(19) United States
(12) Patent Application Publication
(10) Pub. No.: US 2005/0265242 A1
(43) Pub. Date: Dec. 1, 2005

(54) COMMUNICATION MONITORING METHOD AND APPARATUS OF SEMICONDUCTOR DEVICES

(76) Inventors: Hsuan-Hsuan Wu, Tai-Chung City (TW); Tsang-Nan Lee, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,382

(22) Filed: Nov. 8, 2004

(30) Foreign Application Priority Data
May 26, 2004 (TW) 093114920

(51) Int. Cl. H04L 1/00

(52) U.S. Cl. 370/241

(57) ABSTRACT

A communication monitoring method and apparatus of semiconductor devices for receiving messages transmitted between a host and an equipment. The method includes receiving a message, recording the message, determining if the message is a control character EOT, setting a flag to be true if the message is the control character EOT, recording and displaying the message if the message is another control character, determining the next message to be a data message if the flag is true, and determining if other data messages are completely received according to the length of the data messages.

### BACKGROUND OF INVENTION

1. Field of the Invention

The invention relates to a communication monitoring method and apparatus, and more particularly, to a communication monitoring method and system of semiconductor devices which adjusts monitoring according to received message contents.

2. Description of the Prior Art

For managing semiconductor devices efficiently, the Japanese company Mitsubishi Corporation develops the Mitsubishi SEMI Equipment Communication (MSEC) to handle the messages transferred between a host and an equipment, and uses control characters and a handshaking protocol to confirm the completeness of the message transference. In a communication process between a host and an equipment, some monitor methods are usually used to abstract and record the messages transferred between the host and the equipment for checking if the messages are successfully transferred between the host and the equipment, and furthermore to analyze the transference condition for realizing the communication condition between the host and the equipment.

For illustrating the communication condition between a host and an equipment, please refer to FIG. 1 and FIG. 2. FIG. 1 is a schematic diagram of a host 10 transferring messages to an equipment 20 of the prior art and FIG. 2 is a schematic diagram of the equipment 20 transferring messages to the host 10 of the prior art. Before the host 10 transfers a MSEC message 16 (or signal) to the equipment 20, the host 10 should transfer a control character ENQ 12, which means en-query, to the equipment 20 to confirm if the connection between the equipment 20 and the host 10 is normal, and after the equipment 20 receives the control character ENQ 12 transferred from the host 10, the equipment 20 will reply with a control character EOT 24, which means end of transfer, to the host 10 to inform the host 10 that the equipment 20 is able to transfer the MSEC message 16. After the host 10 receives a control character EOT 24, the host 10 will transfer the MSEC message 16 to the equipment 20, and after the equipment 20 receives the MSEC message 16, the equipment 20 will reply with a control character ACK 28, which means acknowledge, to represent that the equipment 20 has received the MSEC message 16. However, if the equipment 20 does not receive the MSEC message 16 successfully, the equipment 20 will reply with a control character NAK 29, which means non-acknowledge, to represent that the equipment 20 does not receive the MSEC message 16 successfully. Similarly, before the equipment 20 transfers a MSEC message 26 to the host 10, the equipment 20 will transfer a control character ENQ 22 to the host 10 to confirm if the connection between the host 10 and the equipment 20 is normal, and after the host 10 receives the control character ENQ 22 transferred from the equipment 20, the host 10 will reply with the control character EOT 14 to the equipment 20 to inform the equipment 20 that the host 10 is able to transfer the MSEC message 26. After the equipment 20 receives the control character EOT 14 transferred from the host 10, the equipment 20 will transfer the MSEC message 26 to the host 10, and after the host 10 receives the MSEC message 26, the host 10 will reply with a control character ACK 18, which means acknowledge, to represent that the host 10 receives the MSEC message 26 successfully, but if the host 10 does not receive the MSEC message 26 successfully, the host 10 will reply with a control character NAK 19, which means non-acknowledge, to represent that the host 10 does not receive the MSEC message 26 successfully.

However, the monitor system of the prior art usually only records the communication messages between a host and an equipment, and needs a person to judge the message contents to understand the meaning of the messages and the communication condition. The monitor system of the prior art is not able to adjust the monitor system immediately according to the messages already transferred and received between the host and the equipment such that the monitor system of the prior art is not able to improve the efficiency of the monitor system and immediateness.

### SUMMARY OF INVENTION

Therefore, the main purpose of the present invention provides a communication method and apparatus of semiconductor devices, which operates according to the received message contents to adjust the monitoring for improving the above problem.

According to the claims of the present invention, the present invention discloses a communication monitoring method of semiconductor devices for receiving the messages transferred between a host and an equipment. The method includes receiving a message, recording the message, determining if the message is a control character EOT, starting a true flag if the message is a control character EOT, recording and displaying the control character if the message is another control character, determining the next message to be a data message if the flag is true, and utilizing the length of the data message to determine if other received data messages are finished.

In addition, the present invention further discloses a communication monitoring apparatus of semiconductor devices to execute the communication monitoring method of semiconductor devices of the present invention.

The communication monitoring method and apparatus of the present invention is able to record the message transferred between the host and the equipment, then analyze the transferred message, and adjust the monitor system according to the message transferred between the host and the equipment to know the communication condition between the host and the equipment and manage semiconductor devices more efficiently.

### BRIEF DESCRIPTION OF DRAWINGS

FIG. 1 is a schematic diagram of a message transferred from a host to an equipment according to the prior art.

FIG. 2 is a schematic diagram of a message transferred from an equipment to a host according to the prior art. p FIG. 3 is a schematic diagram of the connection between the communication monitoring apparatus of the present invention and a host and an equipment.

FIG. 4 is a functional flow diagram of the communication monitoring apparatus according to FIG. 3.

### DETAILED DESCRIPTION

Please refer to FIG. 3. FIG. 3 is a schematic diagram of the connection between the communication monitoring apparatus 40 of the present invention and a host and an equipment. The communication monitoring apparatus 40 electrically connects with a host 30 and an equipment 35 by a RS-232 cable. The host 30 includes a RS-232 port 31, the equipment 35 includes a RS-232 port 36, and the communication monitoring apparatus 40 includes a connecting port 41 and a connecting port 43.

A transferring pin 32 of the RS-232 port 31 of the host 30 connects with a receiving pin 39 of the RS-232 port 36 of the equipment 35 by a RS-232 cable. A receiving pin 42 of the connecting port 41 of the communication monitoring apparatus 40 is used to abstract the message transferred from the host 30 to the equipment 35. Similarly, a transferring pin 38 of the RS-232 port 36 of the equipment 35 connects with a receiving pin 33 of the RS-232 port 31 of the host 30 by a RS-232 cable. A receiving pin 44 of the connecting port 43 of the communication monitoring 40 is used to abstract the message transferred from the equipment 35 to the host 30.

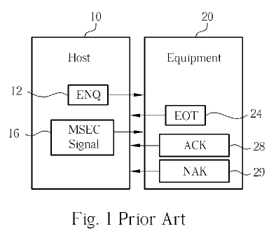

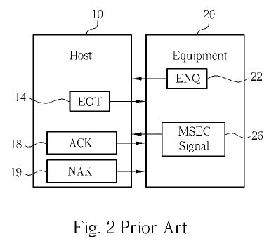

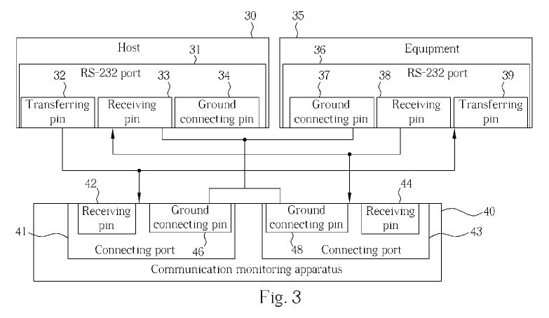

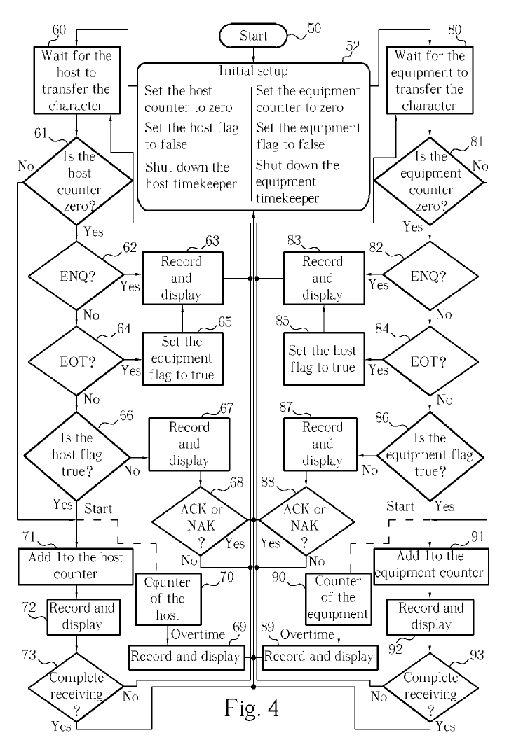

The communication monitoring apparatus 40 of the present invention utilizes the communication monitoring method of the present invention to monitor the communication condition between a host and an equipment. FIG. 4 is a flow chart of the communication monitoring method according to the present invention. FIG. 4 is used to interpret the communication monitoring method of the present invention, so please refer to FIG. 1 to FIG. 4 simultaneously.

According to the RS-232 communication protocol, a character is used as a unit of a message to perform transferring while the host 30 communicates with the equipment 35. Therefore, whenever the communication monitoring apparatus 40 receives any character message by the receiving pin 42 or 44, the communication monitoring apparatus 40 will determine that it is a control character of the communication protocol such as ENQ, EOT, ACK and NAK, or a portion of the MSEC message.

The communication monitoring method of the present invention utilizes a host counter, a host flag, a host timekeeper 70, an equipment counter, an equipment flag and an equipment timekeeper 90 to receive the message transferred between the host 30 and the equipment 35. The host counter is used to confirm the MSEC message data length received from the host 30 by the receiving pin 42. If the character received by the receiving pin 42 is the control character of the communication protocol, the recorded value will not be changed, but if the character received by the receiving pin 42 is a portion of the MSEC message, the recorded value will be added. Similarly, the equipment counter is used to confirm the MSEC message data length received from the equipment 35 by the receiving pin 44. If the character received by the receiving pin 44 is the control character of the communication protocol, the recorded value will not be changed, but if the character received by the receiving pin 44 is a portion of the MSEC message, the recorded value will be added. Moreover, the host flag mentioned before is used to represent if the character received by the receiving pin 42 is a portion of the MSEC message, and the equipment flag is used to represent if the character received by the receiving pin 44 is a portion of the MSEC message. The host timekeeper 70 is used to control the receiving pin 42 to receive messages, and the equipment timekeeper 90 is used to control the receiving pin 44 to receive messages.

According to a preferred embodiment of the present invention, the functional flow of monitoring the messages transferred from the host 30 to the equipment 35 includes:

Step 50: start;

Step 52: perform an initial setup with the communication monitoring apparatus 40 to set the host counter and the equipment counter to zero, set the host flag and equipment flag to false, shut down the host timekeeper 70 and the equipment timekeeper 90, and then the receiving pin 42 and the receiving pin 44 execute step 60 and step 80 respectively;

Step 60: wait for the receiving pin 42 to receive the character from the host 30, and after receiving the character execute step 61;

Step 61: determine if the value recorded by the host counter is zero, execute step 62 if the value recorded by the host counter is zero, or execute step 71 if the value recorded by the host counter is not zero which means the character received by the receiving pin 42 is a portion of the MSEC message;

Step 62: determine if the character received by the receiving pin 42 is a control character ENQ, execute step 63 if the character received by the receiving pin 42 is the control character ENQ, or execute step 64 if the character received by the receiving pin 42 is not the control character ENQ;

Step 63: record the character received by the receiving pin 42, and then execute step 60;

Step 64: determine if the character received by the receiving pin 42 is a control character EOT, execute step 65 if the character received by the receiving pin 42 is the control character EOT which means the host 30 is ready to receive the MSEC message transferred from the equipment 35, and execute step 66 if the character received by the receiving pin 42 is not the control character EOT;

Step 65: set the equipment flag to true such as the communication monitoring apparatus 40 is able to determine according to the equipment flag if the host 30 is ready to receive the MSEC message transferred from the equipment 35, and act as the basis of the following step 86 performing judgment. And then execute step 63;

Step 66: determine if the host flag is true, and if the host flag is true, it represents that the receiving pin 44 has already received the control character EOT transferred from the host 30 to the equipment 35, the host 30 is ready to receive the MSEC message transferred from the equipment 35, and the character received by the receiving pin 42 abstracts from the MSEC message. And then execute step 71, or execute step 67 if the host flag is not true which means the host 30 does not receive the MSEC message transferred from the equipment 35 normally;

Step 67: record the character received by the receiving pin 42, and then execute step 68;

Step 68: determine if the character received by the receiving pin 42 is the control character ACK or NAK, execute step 52 if the character received by the receiving pin 42 is ACK or NAK which means the message is finished with the transfer, or execute step 60 if the character received by the receiving pin 42 is not control character ACK or NAK;

Step 71: add 1 to the value of the host counter to record the data amount of the MSEC message received by the receiving pin 42 at present, and then execute step 72;

Step 72: record, display, and analyze the character that the receiving pin 42 abstracts from the MSEC message, and then execute step 73;

Step 73: get the data length of the MSEC message according to the first character belonging to the MSEC message received by the receiving pin 42, and according to the data length of the MSEC message and the value of the host counter to determine if the receiving pin 42 has completed receiving the MSEC message, if the value of the host counter is equal to the data length of the MSEC message which means the MSEC message is received by the receiving pin 42 completely, execute step 52 if the MSEC message is received by the receiving pin 42 completely, or execute step 60 if the MSEC message is not received by the receiving pin 42 completely;

According to a preferred embodiment of the present invention, steps 80 to 93, which represent a functional flow of monitoring the message transferred from the equipment 35 to the host 30, include:

Step 80: wait for the receiving pin 44 to receive the character from the equipment 35, and after receiving the character execute step 81;

Step 81: determine if the value recorded by the equipment counter is zero, execute step 82 if the value recorded by the equipment counter is zero, or execute step 89 if the value recorded by the equipment counter is not zero which means the character received by the receiving pin 44 is a portion of the MSEC message;

Step 82: determine if the character received by the receiving pin 44 is a control character ENQ, execute step 83 if the character received by the receiving pin 44 is the control character ENQ, or execute step 84 if the character received by the receiving pin 44 is not the control character ENQ;

Step 83: record the character received by the receiving pin 44, and then execute step 80;

Step 84: determine if the character received by the receiving pin 44 is a control character EOT, execute step 85 if the character received by the receiving pin 44 is the control character EOT which means the equipment 35 is ready to receive the MSEC message transferred from the host 30, and execute step 86 if the character received by the receiving pin 44 is not the control character EOT;

Step 85: set the host flag to true such as the communication monitoring apparatus 40 is able to determine according to the host flag if the equipment 35 is ready to receive the MSEC message transferred from the host 30, and act as the basis of the above step 66 performing judgment. And then execute step 83;

Step 86: determine if the equipment flag is true, and if the equipment flag is true, it represents that the receiving pin 42 has already received the control character EOT transferred from the equipment 35 to the host 30, the equipment 35 is ready to receive the MSEC message transferred from the host 30, and the character received by the receiving pin 44 abstracts from the MSEC message. And then execute step 91, or execute step 87 if the equipment flag is not true which means the equipment 35 does not receive the MSEC message transferred from the host 30 normally;

Step 87: record the character received by the receiving pin 44, and then execute step 88;

Step 88: determine if the character received by the receiving pin 44 is the control character ACK or NAK, execute step 52 if the character received by the receiving pin 44 is ACK or NAK which means the message is finished with the transfer, or execute step 80 if the character received by the receiving pin 44 is not control character ACK or NAK;

Step 91: add 1 to the value of the equipment counter to record the data amount of the MSEC message received by the receiving pin 44 at present, and then execute step 92;

Step 92: record, display, and analyze the character that the receiving pin 44 abstracts from the MSEC message, and then execute step 93; and

Step 93: get the data length of the MSEC message according to the first character belonging to the MSEC message received by the receiving pin 44, and according to the data length of the MSEC message and the value of the equipment counter to determine if the receiving pin 44 has completed receiving the MSEC message. Execute step 52 if the value of the equipment counter is equal to the data length of the MSEC message which means MSEC message is received by the receiving pin 44 completely, or execute step 80 if MSEC message is not received by the receiving pin 44 completely.

In addition, please refer to FIG. 4. When the receiving pin 42 receives the character transferred from the host 30 belonging to the MSEC message, the host timekeeper is started and initialed to determine if the receiving pin 42 receives any character in a first expecting period. If the receiving pin 42 does not receive any character in the first expecting period mentioned before which is detected after counting time by the host timekeeper 70, step 69 will be executed to record and display this abnormal condition, and then step 52 will be executed to initialize the communication monitoring apparatus 40. Similarly, when the receiving pin 44 receives the character transferred from the equipment 35 belonging to the MSEC message, the equipment timekeeper is started and initialed to determine if the receiving pin 44 receives any character in a second expecting period. If the receiving pin 44 does not receive any character in the second expecting period mentioned before which is detected after counting time by the equipment timekeeper 90, step 89 will be executed to record and display this abnormal condition, and then step 52 will be executed to initialize the communication monitoring apparatus 40.

Recording characters and messages which is mentioned above such as step 63, 67, 69, 83, 87, and 89 further includes displaying with a word format by a screen or printing on papers, and the present invention is not restricted in these.

When the communication monitoring apparatus is really used with the communication monitoring method of the present invention, as shown in FIG. 4, after initializing variables, the receiving pins connecting between the host and the equipment all await message inputting. Once a message is input, the monitor method of the present invention is briefly described as follows:

If abstracting the ENQ message, only displaying and recording needs to be performed. Wait for the next character to be input.

If abstracting the EOT message, the message flag of the receiver is set to true which represents that the other receiver receives a message afterward.

When the flag of the transmitter is not true, if the receiving pin abstracts a ACK or NAK message, it represents that the command is the end of transmission, which means success or failure, so all variables need to be initialized.

When the flag of the transmitter is true, if the receiving pin abstracts messages not belonging to control characters such as ENQ, EOT, ACK, or NAK, only displaying and recording need to be performed. Wait for next character to be input.

If abstracting the message in the condition that abstracts ENQ and the flag of the transmitter is true, the message length is known from the first character of the message. After finishing receiving the whole message, initialize all variables, and wait for another command. In addition, the timekeeper is need to be restarted each time a message character is abstracted. If the message does not finish receiving and is over the setting time of the timekeeper, the skill machine will send a command to initialize all variables, and waits for the next command.

In the embodiment of the present invention, the host 30, the equipment 35, and the communication monitoring apparatus 40 are all electrically connected with each other except for the ground connecting pin 34 of the RS-232 port 31, the ground connecting pin 37 of the RS-232 port 36, the ground connecting pin 46 of the connecting port 41, and the ground connecting pin 48 of the connecting port 43. The host 30 and the equipment 35 communicate with each other according to the MSEC communication protocol, and the communication monitoring apparatus 40 is used to receive, abstract, and record the message transferred between the host 30 and the equipment 35. In addition, according to the connection structure of the host 30, the equipment 35, and the communication monitoring apparatus 40 as shown in FIG. 1, the communication between the host 30 and the equipment 35 is not influenced while the communication monitoring apparatus breaks down.

Comparing to the prior art, the communication monitoring method and system of the present invention is able to abstract, record, and display the message transferred between the host and the equipment, further to analyze the transferred message, and according to the message transferred between the host and the equipment to adjust the monitor system to understand the working condition between the host and the equipment immediately and find the communication problem quickly in order to manage the semiconductor devices efficiently. Moreover, the present invention does not need to change the system structure between the existing host and the equipment, so the communication between the host 30 and the equipment 35 is not influenced while the communication monitoring apparatus breaks down.

Those skilled in the art will readily observe that numerous modifications and alterations of the device may be made while retaining the teachings of the invention. Accordingly, the above disclosure should be construed as limited only by the metes and bounds of the appended claims.

1. A communication monitoring method of semiconductor devices comprising:
(a) performing an initial setup, setting a counter to zero and a first flag to false;
(b) receiving a character;
(c) determining if the value recorded by the counter is zero, and then executing step (d) if the value recorded by the counter is zero or executing step (k) if the value recorded by the counter is not zero;
(d) determining if the received character is a control character ENQ, representing en-query, and then executing step (e) if the received character is a control character ENQ or executing step (f) if the received character is not a control character ENQ;
(e) recording the received character;
(f) determining if the received character is a control character EOT, representing end of transfer, and then executing step (g) if the received character is a control character EOT or executing step (h) if the received character is not a control character EOT;
(g) setting a second flag to true, and then executing step (e);
(h) determining if the first flag is true, and then executing step (j) if the flag is true or executing (i) if the flag is not true;
(i) recording the received character;
(j) adding 1 to the value of the counter;
(k) recording the received character; and
(l) determining if the receiving is completed.

2. The communication monitoring method of claim 1, wherein step (e) further comprises executing step (b) after recording the received character.

3. The communication monitoring method of claim 1, wherein step (i) further comprises determining if the received character is a control character ACK, representing acknowledge, or a control character NAK, representing non-acknowledge, after recording.

4. The communication monitoring method of claim 3 further comprising executing step (a) if the received character is the control character ACK or NAK.

5. The communication monitoring method of claim 3 further comprising executing step (b) if the received character is neither the control character ACK nor NAK.

6. The communication monitoring method of claim 1, wherein if the first flag is true, step (h) further comprises starting a timekeeper to determine if the message received is delayed.

7. The communication monitoring method of claim 6, wherein if the timekeeper determines the message receiving to be delayed, the message is recorded.

8. The communication monitoring method of claim 6 further comprising executing step (a) and shutting down the timekeeper.

9. The communication monitoring method of claim 1, wherein if step (l) determines that the receiving is not finished, step (b) is executed.

10. The communication monitoring method of claim 1, wherein if step (l) determines that the receiving is finished, step (a) is executed.

11. The communication monitoring method of claim 1, wherein the character is transferred from a host to an equipment, the first flag is the host flag, and the second flag is the equipment flag.

12. The communication monitoring method of claim 1, wherein the character EOT is transferred from an equipment to a host, the first flag is the equipment flag, and the second flag is the host flag.

13. The communication monitoring method of claim 1, wherein the message transferred between the host and the equipment is transferred according to Mitsubishi SEMI Equipment Communication (MSEC).

14. A communication monitoring apparatus for executing the communication monitoring method of semiconductor devices of claim 1.

15. The communication monitoring apparatus of claim 14, wherein the communication monitoring apparatus connects with a host and an equipment by a RS-232 cable.

16. The communication monitoring apparatus of claim 14 further comprising a receiving pin for receiving the character transferred from the host to the equipment.

17. The communication monitoring apparatus of claim 14 further comprising a receiving pin for receiving the character transferred from the equipment to the host.

18. A communication monitoring method of semiconductor devices for receiving messages transferred from a host to an equipment comprising:
(a) performing an initial setup, setting a counter of the host to zero, setting a first flag of the host to false and shutting down a timekeeper of the host;
(b) waiting for the host to transfer a character;
(c) receiving a character from the host to determine if the value recorded by the counter of the host is zero, and then executing step (d) if the value recorded by the counter of the host is zero or executing step (k) if the value recorded by the counter of host is not zero;
(d) determining if the received character is a control character ENQ, representing en-query, and then executing step (e) if the received character is a control character ENQ or executing step (f) if the received character is not a control character ENQ;
(e) recording the received character and executing step (b);
(f) determining if the received character is a control character EOT, representing end of transfer, and then executing step (g) if the received character is a control character EOT or executing step (h) if the received character is not a control character EOT;
(g) setting up a flag of the equipment to true, and then executing step (e);
(h) determining if the flag of the host is true, and then executing step (k) if the flag of host is true or executing (i) if the flag of host is not true;
(i) recording the received character;
(j) determining if the received character is a control character ACK, representing acknowledge, or a control character NAK, representing non-acknowledge, and then executing step (a) if the received character is the control character ACK or NAK representing end of message transfer or executing step (b) if the received character is not the control character ACK or NAK;
(k) starting a timekeeper of the host to determine if the message receiving is delayed, and then recording the message and executing step (a) if the timekeeper of the host determines that the message receiving is delayed;
(l) adding 1 to the value of the counter of the host;
(m) recording the received character; and
(n) obtaining the length of the message data according to the character of the first received message, then determining if the message receiving is finished according to the length of the message data and the value of the counter, and then executing step (b) if the message receiving is not finished or executing step (a) if the message receiving is finished.

19. A communication monitoring method of semiconductor devices for receiving messages transferred from an equipment to a host comprising:
(a) performing an initial setup, setting a counter of the equipment to zero, setting a first flag of the equipment to false and shutting down a timekeeper of the equipment;
(b) waiting for the equipment to transfer a character;
(c) receiving a character from the equipment to determine if the value recorded by the counter of the equipment is zero, and then executing step (d) if the value recorded by the counter of the equipment is zero or executing step (k) if the value recorded by the counter of the equipment is not zero;
(d) determining if the received character is a control character ENQ, representing en-query, and then executing step (e) if the received character is a control character ENQ or executing step (f) if the received character is not a control character ENQ;
(e) recording the received character and executing step (b);
(f) determining if the received character is a control character EOT, representing end of transfer, and then executing step (g) if the received character is a control character EOT or executing step (h) if the received character is not a control character EOT;
(g) setting up a flag of the host to true, and then executing step (e);
(h) determining if the flag of the equipment is true, and then executing step (k) if the flag of the equipment is true or executing (i) if the flag of the equipment is not true;
(i) recording the received character;
(j) determining if the received character is a control character ACK, representing acknowledge, or a control character NAK, representing non-acknowledge, and then executing step (a) if the received character is the control character ACK or NAK representing end of message transfer or executing step (b) if the received character is not the control character ACK or NAK;
(k) starting a timekeeper of the equipment to determine if the message receiving is delayed, and then recording the message and executing step (a) if the timekeeper of the equipment determines that the message receiving is delayed;
(l) adding 1 to the value of the counter of the equipment;
(m) recording the received character; and
(n) obtaining the length of the message data according to the character of the first received message, then determining if the message receiving is finished according to the length of the message data and the value of the counter, and then executing step (b) if the message receiving is not finished or executing step (a) if the message receiving is finished.
